(19) United States
(12) Patent Application Publication
(10) Pub. No.: US 2005/0069461 A1
(43) Pub. Date: Mar. 31, 2005

(54) Multi-purpose multi-function surface-tension microfluidic manipulator

(76) Inventors: Thomas G. Thundat, Knoxville, TN (US); Rubye H. Farahi, Oak Ridge, TN (US); Thomas L. Ferrell, Knoxville, TN (US); Zhiyu Hu, Knoxville, TN (US)

Correspondence Address: UT-Battelle, LLC;Office of Intellectual Property, One Bethal Valley Road, 4500N, MS-6258, Oak Ridge, TN, 37831, US

(21) Appl. No.: 10/673,716

(22) Filed: Sep. 29, 2003

(51) Int. Cl. B01L 11/00

(52) U.S. Cl. 422/101

(57) ABSTRACT

A number of thermal elements are used in a microfluidic device to move or manipulate nano-liter and pico-liter amounts of adsorbed fluid analytes and reagents on the device surface. All of the basic microfluidic operations of transport, merge, subdivide, separate, sort, remove, and capture are provided. A typical device embodiment has a flat or curved surface with the thermal elements located at or near the surface and arranged in any of a number of patterns that make possible specific manipulations of the adsorbed fluids on the surface. The thermal elements may be electrical resistive heaters or Peltier Effect junctions, and are activated by a series of electrical pulses from a control means. The heated or cooled thermal elements produce localized thermal gradients in the surface which in turn induce a surface tension gradient between the adsorbed fluid and the surface, making possible a variety of fluid manipulations on the surface.

### STATEMENT REGARDING FEDERALLY SPONSORED RESEARCH OR DEVELOPMENT

The United States Government has rights in this invention pursuant to contract no. DE-AC05-00OR22725 between the United States Department of Energy and UT-Battelle, LLC.

### FIELD OF THE INVENTION

The present invention relates to microfluidic devices capable of manipulating fluid analytes and reagents adsorbed onto the device surface. The device provides the basic microfluidic operations of transport, merge, subdivide, separate, sort, remove, and capture. These operations are made possible by controlling the generation and placement of localized thermal gradients that induce localized surface tension gradients in the fluids on the surface.

### BACKGROUND OF THE INVENTION

The need for a cost-effective and flexible microfluidic device that can readily manipulate nano-liter and pico-liter amounts of fluids is increasingly important as many fields of science explore the nanometer regime. Popular methods for handling microfluids use a physical flow path such as micro-channels or hydrophilic/hydrophobic patterns. All physical paths have the drawback of a static channel network, limiting the fluid to a predefined route.

Often in microfluidic systems, flow actuation is accomplished by non-mechanical means such as dielectrophoretic forces and surface tension. In the presence of a surface tension gradient it is well known that fluids adsorbed onto a surface can be laterally transported. Adsorbed fluids move from a high temperature region to a lower temperature region. This surface-tension-driven fluid motion is called the Marangoni effect (1, 2).

A surface tension gradient can be produced by several approaches: chemical, composition, thermal, electrochemical, and photochemical. Chemical and composition gradients usually result in static surface tension heterogeneity. The latter three approaches lend the possibility of a dynamically applied surface tension gradient at one or more specified locations, of which thermal is the most versatile since it does not require special reactant chemicals. In addition, all analytes have characteristic thermophysical properties that will respond differently to a surface tension gradient, making possible the selective transport of analytes based on species. Since a thermal gradient causes a surface tension gradient, which in turn causes adsorbate motion, the terms thermal gradient and surface tension gradient will be used interchangeably. Also, the terms analyte, reagent, adsorbed mass, molecules adsorbed onto a surface, fluid adsorbed onto a surface, and fluid will be used interchangeably.

Our device utilizes a controllable array of micro-scale surface or sub-surface thermal elements that can be made to produce dynamic, micro-scale, overlapping surface tension gradients on demand. The result is the precise production and placement of locally confined surface tension gradients that make possible the basic microfluidic operations of transport, merge, subdivide, separate, sort, remove (desorb), and capture (adsorb).

Transport occurs when a thermal gradient is produced directly under the analyte, causing the analyte to move in one direction. Merging occurs when one or more fluids are transported to the same location, causing the analytes to collide into one adsorbate mass. Subdivision occurs when the source of heat, either a dot or line, is directly underneath the analyte and a thermal gradient radiates in all directions from that source, causing the adsorbate mass to split into two or more smaller adsorbate masses. Separation occurs when a thermal gradient of a particular temperature distribution causes only one type of analyte to be transported. Sort occurs when separated analytes are ordered through transport. Removal occurs when the temperature of the surface directly under the analyte is above its vaporization point, causing the analyte to evaporate or sublimate off the surface. Capture occurs when the temperature of the surface is cooled, causing fluid to be adsorbed onto the surface.

This versatile microfluidic device has many applications, including “laboratories on a chip” (lab-on-a-chip) and pre-concentration. Lab-on-a-chip technologies offer disposable, fast, and inexpensive chemical experiments. By spatially controlling molecules adsorbed onto a surface, the device permits micro-scale studies of chemistry, biology, and physics. For example, fundamental studies in surface tension and interface phenomena can be explored with the operations of transport, merge, subdivide, separate, sort, remove, and capture. The device allows micro-chemical analysis of complex fluids. Analytes, cells, proteins, and DNA may be transported, separated, sorted, and merged. Micro-scale reactions may be executed by merging individual reactants in an ordered sequence.

Another application of this microfluidic device is a preconcentrator to increase detection sensitivity of analytical instruments such as gas chromatographs, chemiluminescence detectors or thermal energy analyzers, ion mobility spectrometers, mass spectrometers, micro-electro-mechanical-system (MEMS) sensors, and other sensor/detector devices. Most preconcentrators are cumbersome instruments that draw a large volume of air, collect organic compounds from the surroundings onto a chemical filter, and vaporize the organics into the analytical instrument. Our microfluidic device can perform the same function in an economical, compact manner.

A particularly valuable application of our invention is a preconcentrator to a MEMS sensor. Because of their small mass, MEMS-based sensors offer a number of unique and distinct advantages. However for a MEMS sensor, a Faustian bargain exists between sensitivity and probability. For example, one type of MEMS sensor is the microcantilever (3), where single molecules adsorbed on the cantilever surface can be detected but whose surface area is only about 10⁻⁴ cm². The small surface area means that the probability of a particle interacting with the sensor area is extremely low, resulting in lower sensitivity for a given analyte concentration. However, a microfluidic manipulator adsorbing particles onto an area of about 1 cm², concentrating the particles to a smaller area, and delivering the particles to the microcantilever through vaporization, would effectively increase the probability of capturing a particle by a factor of 10⁴. Prior to our invention, none of the currently available technologies have been able to offer a clear path to the development of such an extremely sensitive, hand held, MEMS-based sensor.

Thus, we provide a multipurpose microfluidic device that spatially controls adsorbed molecules on a surface by providing the basic microfluidic operations of transport, merge, subdivide, separate, sort, remove, and capture. Further and other aspects of the present invention will become apparent from the description contained herein.

### REFERENCES

1. Y-T Tseng et. al., “Experimental and Numerical Studies on Micro-Droplet Movement Driven by Marangoni Effect”, IEEE 12th Int. Conf. on Solid State Sensors, Actuators and Microsystems, Boston, Jun. 8-12, 2003, pp. 1879-1882.
2. N. Gamier, et. al., “Optical Manipulation of Microscale Fluid Flow”, Phys. Rev. Lett., Vol. 91.054501, pp. 1-4 (2003).
3. U.S. Pat. No. 5,719,324, issued Feb. 17, 1998, “Microcantilever Sensor”, T. G. Thundat, et. al.

### SUMMARY OF THE INVENTION

In one embodiment, the invention is a microfluidic manipulator for an adsorbed fluid, comprising a material having a surface for adsorbing fluids, the material provided with a plurality of individually controllable thermal elements that produce thermal gradients on the surface that produce surface tension gradients at the interface between the adsorbed fluid and the surface sufficient to cause the adsorbed fluid to move on the surface; wherein one or more of the thermal elements are controlled to transport adsorbed fluids on the surface.

In another embodiment, the invention is a microfluidic manipulator for an adsorbed fluid, comprising a material having a surface for adsorbing fluids, the material provided with a plurality of individually controllable thermal elements that produce thermal gradients on the surface that produce surface tension gradients at the interface between the adsorbed fluid and the surface sufficient to cause the adsorbed fluid to move on the surface; wherein one or more of the thermal elements are controlled to merge adsorbed fluids on the surface.

In a further embodiment, the invention is a microfluidic manipulator for an adsorbed fluid, comprising a material having a surface for adsorbing fluids, the material provided with a plurality of individually controllable thermal elements that produce thermal gradients on the surface that produce surface tension gradients at the interface between the adsorbed fluid and the surface sufficient to cause the adsorbed fluid to move on the surface; wherein one or more of the thermal elements are controlled to subdivide adsorbed fluids on the surface.

In a still further embodiment, the invention is a microfluidic manipulator for an adsorbed fluid, comprising a material having a surface for adsorbing fluids, the material provided with a plurality of individually controllable thermal elements that produce thermal gradients on the surface that produce surface tension gradients at the interface between the adsorbed fluid and the surface sufficient to cause the adsorbed fluid to move on the surface; wherein one or more of the thermal elements are controlled to separate adsorbed fluids on the surface.

In yet another embodiment, the invention is a microfluidic manipulator for an adsorbed fluid, comprising a material having a surface for adsorbing fluids, the material provided with a plurality of individually controllable thermal elements that produce thermal gradients on the surface that produce surface tension gradients at the interface between the adsorbed fluid and the surface sufficient to cause the adsorbed fluid to move on the surface; wherein one or more of the thermal elements are controlled to sort adsorbed fluids on the surface.

### BRIEF DESCRIPTION OF THE DRAWINGS

FIG. 1 illustrates an embodiment of the invention that features thermal elements in the form of non-intersecting lines.

FIG. 2 illustrates an embodiment of the invention that features thermal elements in the form of an X-Y orthogonal system of lines.

FIG. 3 illustrates an embodiment of the invention that features thermal elements in the form of non-intersecting closed lines.

FIG. 4 illustrates an embodiment of the invention that features thermal elements in the form of an R-θ system of orthogonal lines.

FIG. 5 illustrates an embodiment of the invention that features thermal elements in the form of a combination of patterned lines.

FIG. 6 illustrates an embodiment of the invention that features thermal elements and a micro-electro-mechanical-system (MEMS) sensor/detector.

FIG. 7 illustrates an embodiment of the invention that features collectively controlled thermal elements.

FIG. 8 illustrates an embodiment of the invention that features thermal elements in the form of an array of dots.

FIG. 9 illustrates an embodiment of the invention that features thermal elements in the form of a stochastic system of dots of various sizes.

FIG. 10 illustrates an embodiment of the invention that features thermal elements in the form of a combination of lines and dots.

FIGS. 11 and 12 illustrate the transport operation of the invention using the embodiment of FIG. 2.

FIGS. 13 and 14 illustrate the subdivide operation of the invention using the embodiment of FIG. 2.

FIGS. 15 and 16 illustrate the subdivide operation of the invention using the embodiment of FIG. 8.

FIGS. 17 and 18 illustrate the merge operation of the invention using the embodiment of FIG. 2.

FIGS. 19 through 21 illustrate the separate operation of the invention using the embodiment of FIG. 2.

FIGS. 22 and 23 illustrate the sort operation of the invention using the embodiment of FIG. 2.

FIGS. 24 through 26 illustrate the desorb operation of the invention using the mbodiment of FIG. 8.

FIGS. 27 and 28 illustrate the adsorb operation of the invention using the embodiment of FIG. 8.

FIG. 29 illustrates the FIG. 2 embodiment of the invention in more detail, and also illustrates a control system that may be used with all the embodiments of the invention.

FIG. 30 illustrates the embodiment of FIG. 29 in further detail.

FIG. 31 illustrates the embodiment of FIG. 29 in still further detail.

FIG. 32 illustrates the transport operation of the embodiment of FIG. 29.

FIG. 33 also illustrates the transport operation of the embodiment of FIG. 29

### DETAILED DESCRIPTION OF THE INVENTION

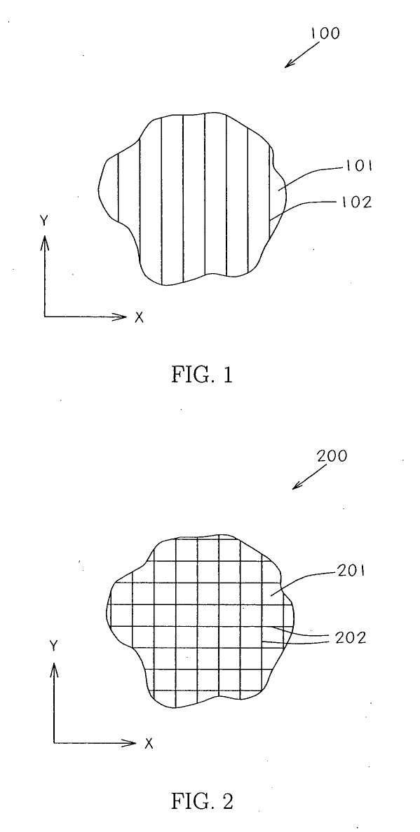

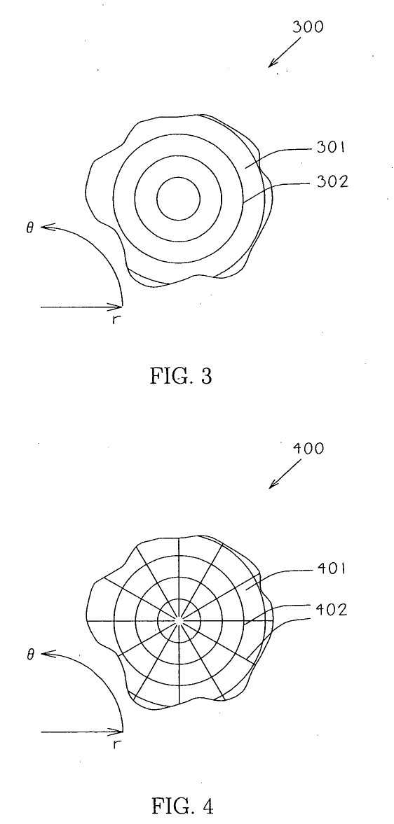

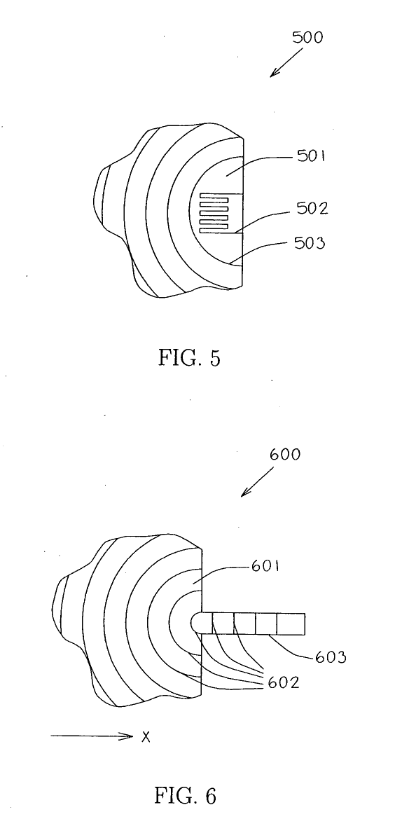

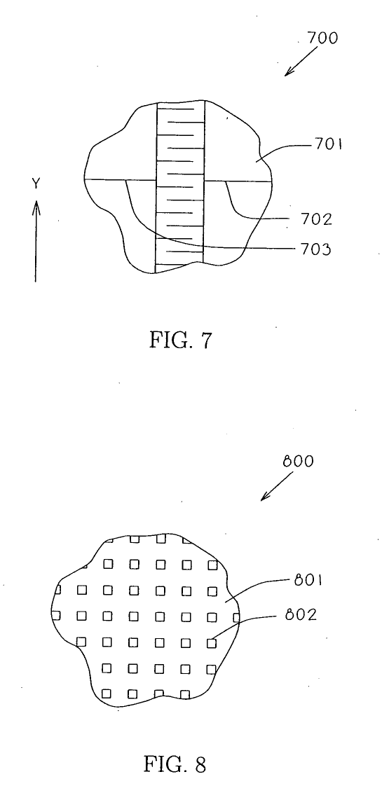

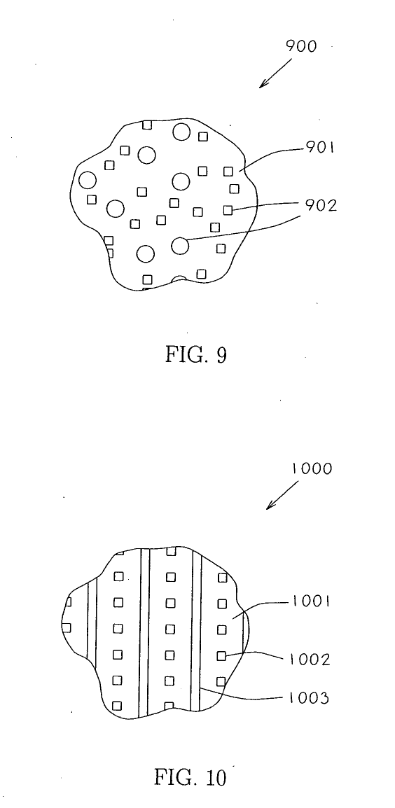

The microfluidic manipulator is illustrated in ten embodiments in FIGS. 1-10. In all of these embodiments, not drawn to scale, the microfluidic manipulator has a surface upon which the analyte vapors are allowed to adsorb. The manipulator is provided with individually controllable thermal elements that produce thermal gradients on the surface and control the temperature on the surface. The thermal elements may take the form of non-intersecting lines in FIG. 1, an X-Y orthogonal system of lines in FIG. 2, non-intersecting closed lines in FIG. 3, an R-θ system of orthogonal lines in FIG. 4, a combination of patterned lines in FIG. 5, a combination of thermal elements and a micro-electro-mechanical-system (MEMS) sensor/detector as in FIG. 6, collectively controlled thermal elements as in FIG. 7, an array of dots in FIG. 8, a stochastic system of dots of various sizes as in FIG. 9, and a combination of line and dots as in FIG. 10. Fluids are adsorbed and desorbed at selected locations on the surface by controlling the localized surface temperature by the thermal elements. The adsorbed fluids are preferentially manipulated by localized thermal gradients caused by the thermal elements.

In the device embodiments shown in FIGS. 1-10 the microfluidic manipulators 100, 200, 300, 400, 500, 600, 700, 800, 900, 1000 with surfaces 101, 201, 301, 401, 501, 601, 701, 801, 901, 1001 for fluid adsorption may be fabricated from any suitable material that will electrically isolate and sufficiently thermally isolate the thermal elements 102, 202, 302, 402, 502, 503, 602, 702, 703, 802, 902, 1002, 1003. The device can be fabricated from a semiconducting material such as silicon, gallium arsenide, germanium, etc. The device can also be fabricated from insulating materials such as mica, glass, silicon dioxide, silicon nitride, silicon carbide, sapphire, diamond, fused silica, fused quartz, etc. The device may be a polymer such as silicone rubber or polyimide. The material may be rigid or flexible.

The thermal elements 102, 202, 302, 402, 502, 503, 602, 702, 703, 802, 902, 1002, 1003 can be resistive heaters that heat the surface in order to produce a thermal gradient when electrical current is applied. The thermal elements 802, 902, 1002 can also be Peltier Effect junctions that heat or cool the surface in order to produce a thermal gradient, depending on the direction of the applied electrical current. The methods used to fabricate the thermal elements 102, 202, 302, 402, 502, 503, 602, 702, 703, 802, 902, 1002, 1003 include conducting thin films and ion implantation. Conducting or metal thin films may include gold, platinum, palladium, aluminum, nickel, copper, chrome, etc. Compound thin films may include hafnium diboride (HfB₂), titanium-tungsten nitride (TiWN), cobalt silicide (CoSi₂), titanium silicide (TiSi₂) or other silicides (molybdenum, tungsten, magnesium), etc.

In the embodiments of FIGS. 1 and 3, the thermal elements 102, 302 take the form of non-intersecting lines that produce thermal gradients in one direction on the surface 101, 301. In FIG. 1, the thermal elements 102 extending in the Y direction will produce thermal gradients in the X direction. Likewise in FIG. 3, the thermal elements 302 extending in the θ direction will produce thermal gradients in the r direction.

In the embodiments of FIGS. 2 and 4, the thermal lines 202, 402 are disposed orthogonally to be capable of producing thermal gradients in two directions. When a current is passed through individually selected lines 202, 402, the result is two-dimensional control of the thermal gradient in either the X-Y or r-θ direction on the surface 201, 401.

In the embodiment of FIG. 5, the thermal lines 502, 503 take the form of a combination of different line shapes, each operated for a particular fluid manipulation operation. For example, the curved thermal elements 503 can be individually controlled to transport adsorbed fluid onto the alternatingly patterned thermal element 502, after which the thermal element 502 is heated to desorb the fluid off the surface 501. This embodiment would be useful as a preconcentrator for a nearby detector device, for example.

In the embodiment of FIG. 6, the microfluidic manipulator 600 is integrated with a sensor/detector device. A MEMS sensor/detector in the form of a microcantilever 603 is attached to, or made integral with, the surface 601. The thermal elements 602 are controlled in a manner to transport adsorbed fluids from the larger surface 601 onto the much smaller microcantilever 603.

In the embodiment of FIG. 7, two or more thermal elements 702, 703 may be electrically connected to efficiently control the thermal gradient for a specific application. For example, the two sets of thermal lines 702, 703 may be operated consecutively for accelerated transport in the Y direction.

In the embodiments of FIGS. 8 and 9, the thermal elements 802, 902 take the form of dot heaters. These may be resistive heaters or Peltier Effect junctions capable of producing thermal gradients at a single spot on the surface 801, 901 by either heating or cooling the surface. Each element 802, 902 produces a spatially localized thermal gradient on the surface 801, 901 radially direction from that element. The thermal elements 802, 902 in the form of dots can be individually controlled for the microfluidic manipulations of transport, merge, subdivide, separate, and sort. In addition, each thermal element 802, 902 controls the surface temperature at a specific location. Adsorbed fluid may be desorbed, that is, removed from a specific location by heating that location. If the thermal elements 802, 902 are Peltier Effect junctions, a greater adsorption will occur at a specific location on the surface 801, 901 by cooling that location.

In the embodiment of FIG. 10, the thermal elements 1002, 1003 take the form of dots 1002 and lines 1003. The thermal dots 1002 may be Peltier Effect junctions that can both heat and cool while the thermal lines 1003 may be resistive heaters. FIG. 10 thus illustrates the use of both resistive heaters and Peltier Effect junctions.

All of the embodiments of the microfluidic manipulator shown in FIGS. 1-10 may be operated to transport, subdivide, merge, separate, sort, remove, and capture fluids adsorbed onto the surface.

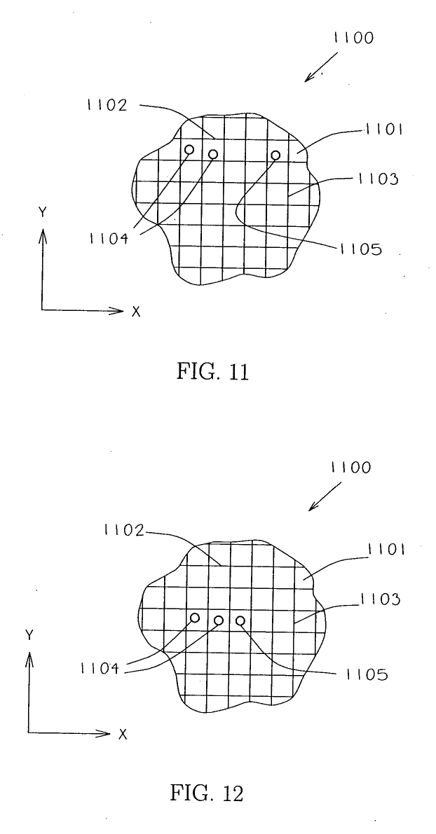

The transporting of adsorbed fluids is illustrated in FIGS. 11 and 12. The device 1100 has a surface 1101 provided with a plurality of mutually orthogonal thermal elements 1102, 1103. Adsorbed fluids 1104, 1105 are present on the surface 1101. The heating elements 1102, 1103 are heated to produce thermal gradients in the Y and X directions, respectively. When the thermal element 1102 is heated, the adsorbed fluids 1104, 1105 are close enough to the thermal element 1102 to be affected by the surface tension gradient, and consequently move in the Y direction away from the higher temperature. This is shown in FIG. 12. Similarly, when the thermal element 1103 is heated, the adsorbed fluid 1105 moves in the X direction away from the higher temperature, also shown in FIG. 12. The adsorbed fluids 1104 are too far away from thermal element 1103, and thus are not moved in the X direction by the surface tension gradient from the thermal element 1103. It is readily seen that the thermal elements 1102, 1103 may be heated consecutively or simultaneously. Thus, by proper design and control of the many thermal elements capable of producing the X and Y thermal gradients, it is possible to efficiently transport adsorbed fluids over the surface 1101. In one example, the transport operation may move adsorbed fluids scattered over a large surface area to one localized area on the surface, thereby concentrating the adsorbed fluids. This embodiment of the invention, then, provides a novel chemical pre-concentrator that could be used, for example, as the front-end to an analytical instrument.

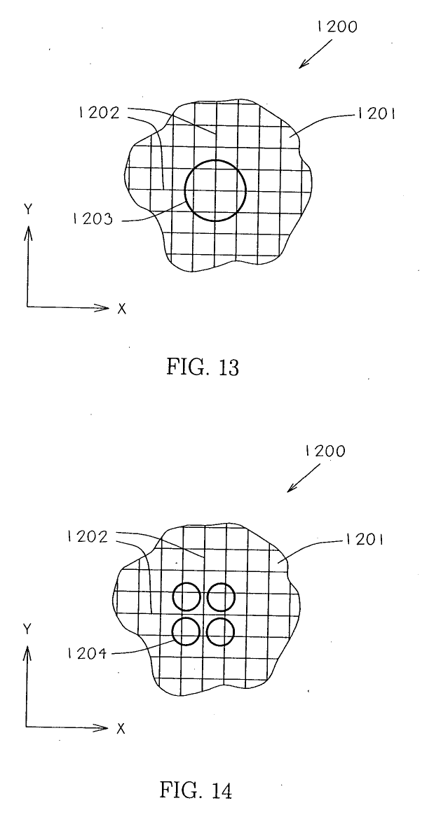

The subdividing of adsorbed fluids is illustrated in the two embodiments shown in FIGS. 13, 14 and 15, 16 respectively. In FIG. 13, the device 1200 has a surface 1201 provided with a plurality of mutually orthogonal thermal elements 1202 on which adsorbed fluids 1203 are present. The heating elements 1202 are heated to produce thermal gradients in the X and Y directions directly under the adsorbed fluid 1203. As a result, the adsorbed fluid 1203 is subdivided into small volumes 1204 on the surface 1201, as shown in FIG. 14.

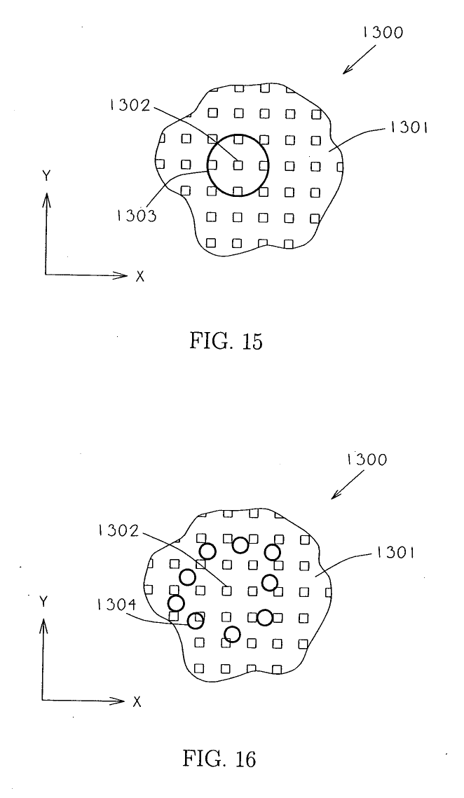

In the other embodiment shown in FIGS. 15, 16, the device 1300 has a surface 1301 provided with a plurality of Peltier Effect heating elements 1302, on which an adsorbed fluid (or fluids) 1303 is present. The Peltier junction 1302 located directly under the adsorbed fluid 1303 is heated to produce a thermal gradient that is radially directed. As a result, the adsorbed fluid 1303 is subdivided into a number of smaller volumes 1304 of varying sizes, as shown in FIG. 16.

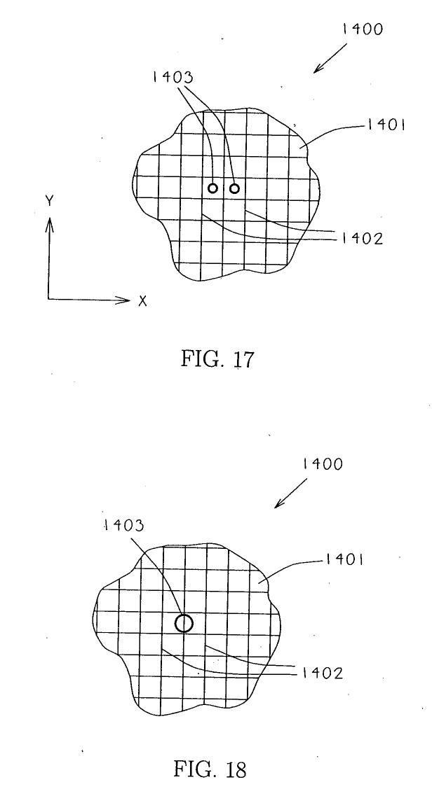

The merging of adsorbed fluids is illustrated in FIGS. 17 and 18. The device 1400 has a surface 1401 provided with a plurality of X-direction and Y-direction thermal elements on which adsorbed fluids 1403 are present. The Y-direction heating elements 1402 are heated to produce thermal gradients in the X direction. As the adsorbed fluids 1403 move away from the regions of higher temperature produced by the thermal elements 1402, the fluids merge to form a larger volume 1404 due to nucleation, as shown in FIG. 18. One application of this embodiment of the invention would be as a surface for merging several different adsorbed species in an ordered sequence for micro-scale reactions.

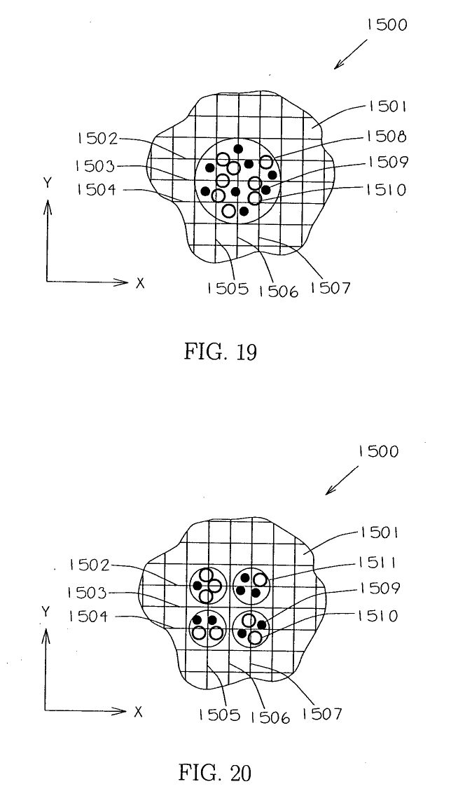

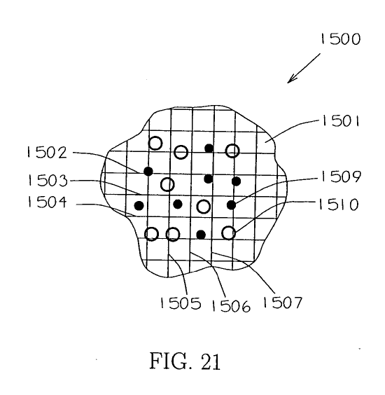

The separating of adsorbed fluids is illustrated in FIGS. 19, 20, and 21. The device 1500 has a surface 1501 provided with thermal elements 1502-1507, on which adsorbed fluids 1508 are present. The adsorbed fluid 1508 is comprised of two dissimilar species 1509, 1510. The thermal elements 1503 and 1506 located directly under the adsorbed fluid volume 1508 are heated to produce thermal gradients in the X and Y directions. As a result of the thermal gradients, the adsorbed fluid 1508 is subdivided into small volumes 1511 on the surface 1501, as illustrated in FIG. 20. The thermal elements 1502, 1504, 1505, 1507 are then heated to produce thermal gradients in the X and Y directions which further subdivide and separate the fluid into smaller volumes of like species, illustrated at 1509, 1510 in FIG. 21. The separation occurs because different species have different surface tension, mass, and mobility, thus the different species will be transported different distances under the influence of the same thermal gradient. This embodiment of the invention can be the basis for a novel way of obtaining chemical selectivity.

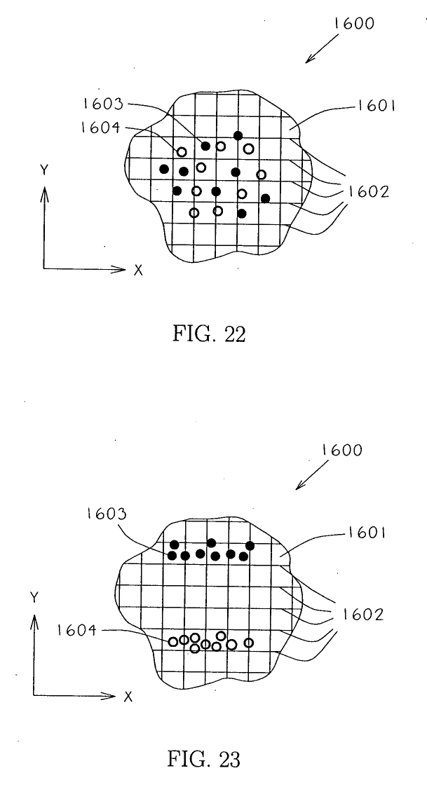

The sorting of absorbed fluids is illustrated in FIGS. 22 and 23. The device 1600 has a surface 1601 provided with thermal elements 1602, on which two dissimilar adsorbed fluids 1603, 1604 are present. The thermal elements 1602 are heated to produce thermal gradients in the Y direction. Because different species have different surface tension, mass, and mobility, they will be transported different distances under the influence of the same thermal gradient. As a result, the two species 1603, 1604 may be sorted to different locations on the surface 1601, as illustrated in FIG. 23.

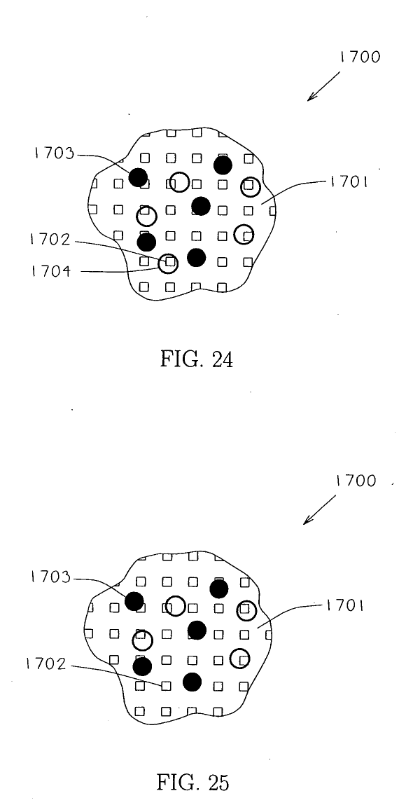

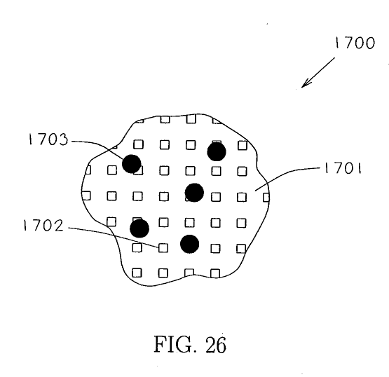

The removal, or desorption, of absorbed fluids is illustrated in FIGS. 24, 25, and 26. The device 1700 has a surface 1701 provided with a plurality of Peltier Effect junctions 1702, on which two dissimilar adsorbed fluids 1703, 1704 are present. The Peltier heating elements 1702 are heated to selectively or collectively produce a surface temperature sufficient to desorb some of the adsorbed fluid from the surface. Because the two dissimilar adsorbed fluids 1703, 1704 will desorb at different surface temperatures, the surface temperature is controlled to affect one species of adsorbed fluid 1703, but not the other 1704, or vice versa. FIG. 25 illustrates, for example, that when the single Peltier heating element 1702 is heated sufficiently, the adsorbed fluid 1704 (shown in FIG. 24) directly over that heating element is removed from the surface 1701. In addition, FIG. 26 shows that when many or all of the Peltier Effect junctions 1702 are heated to precisely control the temperature of the surface 1701, one adsorbed fluid species (1704 in FIG. 23) may be entirely desorbed while the other species 1703 remains on the surface 1701.

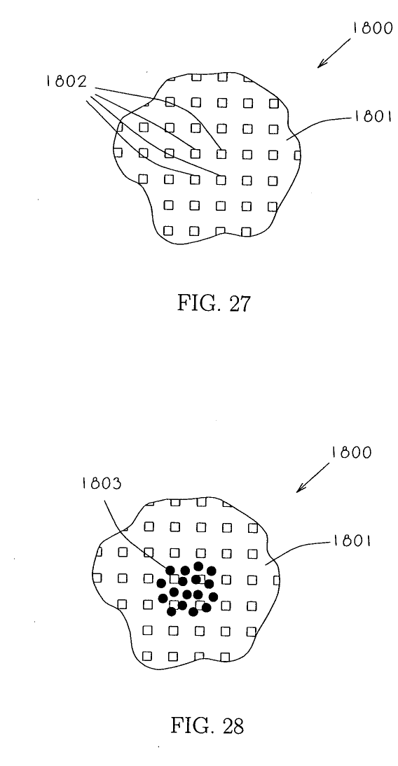

The capturing, or adsorbing, of fluids is illustrated in FIGS. 27 and 28. In FIG. 27, the device 1800 has a surface 1801 provided with Peltier heating elements 1802. The Peltier elements 1802 are cooled in order to produce a low surface temperature at a specific location on the surface 1801. As a result, fluids 1803 from the surroundings will preferentially adsorb at that location, as shown in FIG. 28.

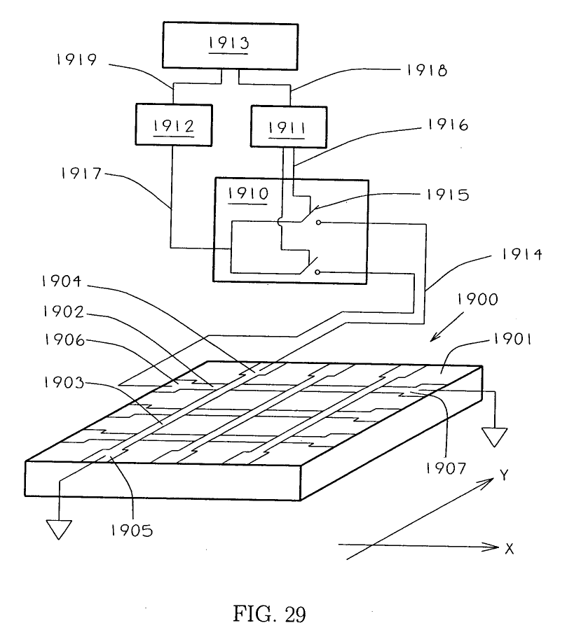

One example of a microfluidic manipulator is illustrated in FIGS. 29-33. In FIG. 29, the microfluidic manipulator 1900 has a surface 1901 provided with thermal elements 1902, 1903 arranged in both the X and Y directions for two-dimensional manipulation of adsorbed fluids. The surface area 1901 for adsorption in this example is about one cm², but can be made any desired area. The thermal elements 1902, 1903 are 10 μm wide, 500 nm thick, 1 cm long, and spaced at a 30 μm pitch. The resistivity of each thermal element is about 100 Ω. The thermal elements 1902, 1903 have pads 1904-1907 at their ends for making external electrical connections. In this example, the pads 1905, 1907 on one side of the thermal elements 1902, 1903 are grounded while the pads 1904, 1906 on the other side of the thermal elements 1902, 1903 are connected with wires 1914 which carry electrical signals that activate the thermal elements 1902, 1903. For example, the electrical signals required to transport an adsorbed fluid may be a pulse of 20 V, 300 mA amplitude, 10 ms width, and 100 ms period with a repetition rate of 20. Such an electrical signal may be generated with a control system that includes a transistor-transistor logic (TTL) controlled switching system 1910, a TTL output module 1911, a programmable DC source 1912, and a computer 1913. The DC source 1912 provides the required voltage and current (20 V-300 mA) to the switching system 1910 with electrical connections 1917. The DC source may be a power supply, batteries, analog or digital output modules, a pulse generator, etc. In this example, all thermal elements operated simultaneously would receive the same voltage and current. However, each thermal element may also be provided with independent power sources. The TTL output module 1911 selects which thermal elements are to be activated by connecting lines 1916 to the TTL control of each switch 1915. In addition, the TTL output module 1911 determines the pulse width (10 ms), period (100 ms), and repetition (20). A separate switch 1915 is provided for each thermal element 1902, 1903 that is individually controlled. The switches 1915 may be relays, monolithic ICs, multiplexers, data acquisition (DAC) modules, field programmable gate arrays (FPGAs), application specific integrated circuits (ASICs), etc. The computer 1913 controls the TTL output module 1911 and the programmable DC power supply 1912 through control lines 1918, 1919.

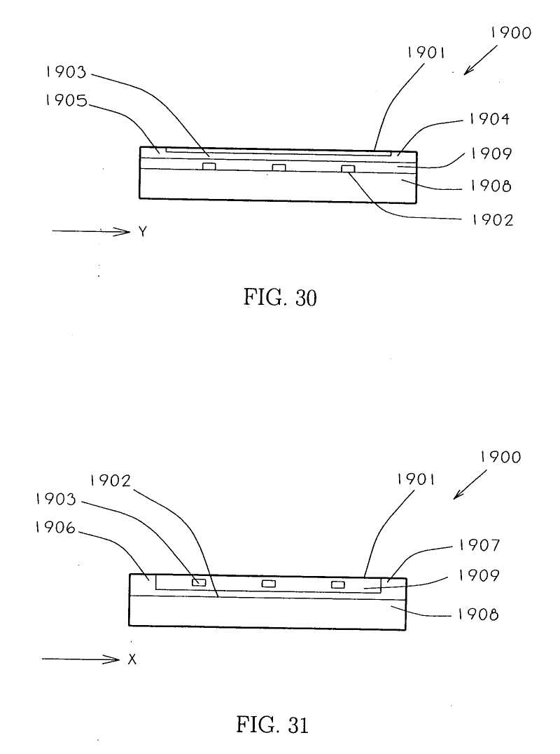

The construction of the microfluidic manipulator 1900 is illustrated in FIGS. 30 and 31. The surface 1901 is depicted as smooth and flat, although any surface topography can be used. A cross-section along a thermal element 1903 in the Y direction is shown in FIG. 30 and a cross-section along a thermal element 1902 in the X direction is shown in FIG. 31, both figures not to scale. A support 1908 serves as a platform on which the thermal elements 1902 1903 are placed. The support 1908 may be made of insulative or semiconducting materials. Insulative materials include silicon dioxide (SiO₂), silicon nitride (Si₃N₄), silicon carbide (SiC), diamond (C), sapphire, ceramic, silica glass, fused silica, fused quartz and mica. Flexible polymeric insulative materials include silicone rubber, and polyimide. Semiconducting materials include silicon, gallium arsenide, and germanium. The support 1908 may be flexible or rigid and its thickness may vary. For example, a 500-micrometer thick fused quartz wafer may serve as the support 1908.

In FIGS. 30 and 31, the thermal elements 1903 in the Y direction are located beneath the surface 1901 while their pads 1904, 1905 are exposed to the surface 1901 for electrical connections. The thermal elements 1902 in the X direction are buried about 50 nm beneath the thermal elements 1903 in the Y direction while their pads 1906, 1907 are exposed to the surface 1901 for electrical connections. The types of thermal elements 1902, 1903 include electrical resistive heaters and Peltier Effect junctions. The methods used to fabricate thermal elements 1902, 1903 include conducting thin films and ion implantation. Conducting thin films may be gold, platinum, palladium, aluminum, nickel, copper, and chrome. Compound thin films may be HfB², TiWN, CoSi₂, TiSi₂ or other silicides (molybdenum, tungsten, magnesium). The pads 1904-1907 are made of a conducting material that may be the same as or similar to the thermal elements 1902, 1903. The thermal elements 1902, 1903 are electrically isolated from each other by means of a surrounding insulative or semiconducting material 1909 similar to the support 1908. These materials provide electrical isolation for the thermal elements 1902, 1903 as well as thermal isolation for spatially localized thermal gradients and heating.

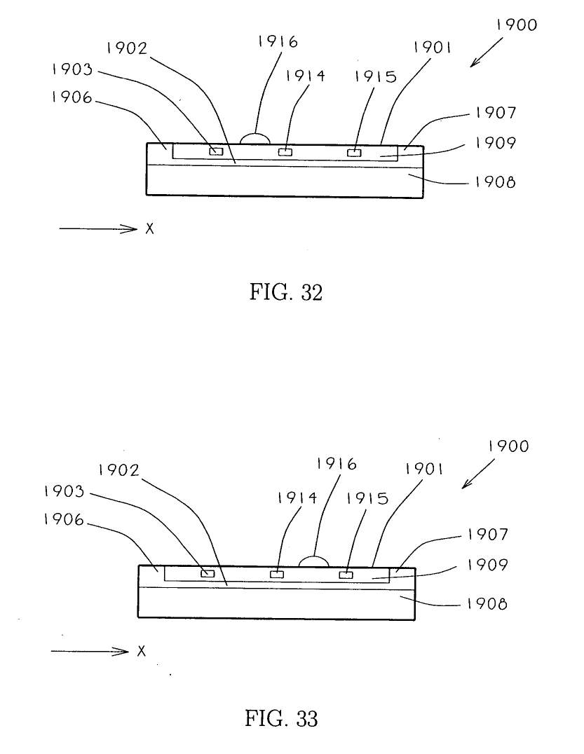

An example of the operation of the microfluidic manipulator 1900 is shown in FIGS. 32 and 33. In FIG. 32, an adsorbed fluid 1916 on the surface 1901 is located to the right of a thermal element 1903. The thermal element 1903 is given one or a series of electrical pulses such that a surface tension gradient (not shown) is produced between the adsorbed fluid 1916 and the surface 1901 in the X direction. The surface tension gradient is such that the adsorbed fluid 1916 is transported in the X direction past the adjacent thermal element 1914, as shown in FIG. 33. Since the transported adsorbed fluid (1916 in FIG. 33) stops to the right of the adjacent thermal element 1914, the thermal element 1914 may in turn be activated so that the adsorbed fluid 1916 continues to be transported to the right in the X direction. Only the number of thermal elements available limits the distance transported. If (in FIG. 32) the surface tension gradient is not capable of transporting the adsorbed fluid 1916 beyond the adjacent thermal element 1914, then the adsorbed fluid will remain between the two thermal elements 1903, 1914. If the thermal elements 1903, 1914 are Peltier Effect devices, then a steeper thermal gradient is created by heating one thermal element 1903 while cooling the adjacent thermal element 1914.

While there has been shown and described what are at present considered the preferred embodiments of the invention, it will be obvious to those skilled in the art that various changes and modifications can be prepared therein without departing from the scope of the invention defined by the appended claims.

1. A microfluidic manipulator for an adsorbed fluid, comprising:
a material having a surface for adsorbing fluids, said material provided with a plurality of individually controllable thermal elements that produce thermal gradients on said surface that produce surface tension gradients at the interface between the adsorbed fluid and said surface sufficient to cause the adsorbed fluid to move on said surface;
wherein one or more of said thermal elements are controlled to transport adsorbed fluids on said surface.

2. The microfluidic manipulator of claim 1 wherein said individually controllable thermal elements are controlled to produce a surface temperature on a portion of said surface sufficient to adsorb fluids onto said portion of said surface.

3. The microfluidic manipulator of claim 1 wherein said individually controllable thermal elements are controlled to produce a surface temperature on a portion of said surface sufficient to desorb adsorbed fluids from said portion of said surface.

4. The microfluidic manipulator of claim 1 further comprising a power source for providing electrical signals to said thermal elements.

5. The microfluidic manipulator of claim 4 wherein said power source is selected from the group consisting of a power supply, batteries, analog or digital output modules, a pulse generator and a programmable DC power supply.

6. The microfluidic manipulator of claim 4 wherein the amplitude of said electrical signal is controlled by said power source.

7. The microfluidic manipulator of claim 4 wherein the phase and delay of said electrical signal is controlled by said power source.

8. The microfluidic manipulator of claim 4 wherein the frequency of said electrical signal is controlled by said power source.

9. The microfluidic manipulator of claim 4 wherein the pulse width of said electrical signal is controlled by said power source.

10. The microfluidic manipulator of claim 4 wherein the current limit of said electrical signal is controlled by said power source.

11. The microfluidic manipulator of claim 4 wherein said electrical signal is programmably controlled.

12. The microfluidic manipulator of claim 4 wherein said electrical signal is manually controlled.

13. The microfluidic manipulator of claim 1 further comprising a means for the selection of which of said thermal elements receive said electrical signals.

14. The microfluidic manipulator of claim 13 wherein said thermal elements selection means is selected from the group consisting of relays, switches, multiplexers, data acquisition modules, field programmable gate arrays, and application specific integrated circuits.

15. The microfluidic manipulator of claim 13 wherein said thermal elements selection means provides for two or more of said thermal elements to be collectively selected.

16. The microfluidic manipulator of claim 1 wherein said thermal elements are connected in series with resistors for monitoring the current through said thermal elements.

17. The microfluidic manipulator of claim 16 wherein said thermal elements are feedback controlled by said monitoring current through said thermal elements.

18. The microfluidic manipulator of claim 1 wherein said thermal elements protrude from said surface.

19. The microfluidic manipulator of claim 1 wherein said thermal elements are flush with said surface.

20. The microfluidic manipulator of claim 1 wherein said thermal elements are within said material beneath said surface.

21. The microfluidic manipulator of claim 1 wherein said thermal elements take the form of round dots on said surface.

22. The microfluidic manipulator of claim 1 wherein said thermal elements take the form of square dots on said surface.

23. The microfluidic manipulator of claim 1 wherein said thermal elements take the form of round and square dots on said surface.

24. The microfluidic manipulator of claim 1 wherein said thermal elements take the form of straight lines.

25. The microfluidic manipulator of claim 1 wherein said thermal elements take the form of curved lines.

26. The microfluidic manipulator of claim 1 wherein said thermal elements take the form of straight lines and curved lines.

27. The microfluidic manipulator of claim 1 wherein said thermal elements take the form of both dots and lines.

28. The microfluidic manipulator of claim 1 wherein said thermal elements are arranged uniformly spaced with respect to each other.

29. The microfluidic manipulator of claim 1 wherein said thermal elements are arranged unevenly spaced with respect to each other.

30. The microfluidic manipulator of claim 1 wherein said thermal elements take the form of straight or curved lines that cross each other on said surface.

31. The microfluidic manipulator of claim 1 wherein said thermal elements take the form of straight or curved lines that do not cross each other on said surface.

32. The microfluidic manipulator of claim 1 wherein said thermal elements are arranged as an orthogonal structure on said surface.

33. The microfluidic manipulator of claim 1 wherein said thermal elements are arranged as non-intersecting closed lines on said surface.

34. The microfluidic manipulator of claim 1 wherein said thermal elements are arranged as concentric circles on said surface.

35. The microfluidic manipulator of claim 1 wherein said thermal elements are resistive heaters.

36. The microfluidic manipulator of claim 1 wherein said thermal elements are Peltier Effect junctions.

37. The microfluidic manipulator of claim 1 wherein said thermal elements are a combination of resistive heaters and Peltier Effect junctions.

38. The microfluidic manipulator of claim 1 wherein at least one of said thermal elements is a thin metal film selected from the group consisting of gold, platinum, palladium, aluminum, nickel, copper and chrome.

39. The microfluidic manipulator of claim 1 wherein at least one of said thermal elements is made of a compound selected from the group consisting of hafnium diboride, titanium-tungsten nitride, cobalt silicide, titanium silicide, molybdenum silicide, tungsten silicide and magnesium silicide.

40. The microfluidic manipulator of claim 1 wherein said thermal elements are made by ion implantation.

41. The microfluidic manipulator of claim 1 wherein said material is a semiconductor selected from the group consisting of silicon, gallium arsenide and germanium.

42. The microfluidic manipulator of claim 1 wherein said material is an insulator selected from the group consisting of silicon dioxide, silicon nitride, silicon carbide, diamond, sapphire, ceramic, silica glass, fused silica, fused quartz and mica.

43. The microfluidic manipulator of claim 1 wherein said material is a polymer selected from the group consisting of silicone rubber and polyimide.

44. The microfluidic manipulator of claim 1 wherein said material is rigid.

45. The microfluidic manipulator of claim 1 wherein said material is flexible.

46. The microfluidic manipulator of claim 1 wherein said adsorbed fluid is desorbed to a nearby detector device.

47. The microfluidic manipulator of claim 46 wherein said detector device is a MEMS sensor.

48. The microfluidic manipulator of claim 47 wherein said MEMS sensor is a microcantilever detector.

49. The microfluidic manipulator of claim 46 wherein said detector device is a surface acoustic wave detector.

50. The microfluidic manipulator of claim 46 wherein said detector device is an anion mobility mass spectrometer.

51. The microfluidic manipulator of claim 1 wherein said material is integrated with a detector device.

52. The microfluidic manipulator of claim 51 wherein said detector device is a MEMS sensor.

53. The microfluidic manipulator of claim 52 wherein said MEMS sensor is a microcantilever detector.

54. A microfluidic manipulator for an adsorbed fluid, comprising:
a material having a surface for adsorbing fluids, said material provided with a plurality of individually controllable thermal elements that produce thermal gradients on said surface that produce surface tension gradients at the interface between the adsorbed fluid and said surface sufficient to cause the adsorbed fluid to move on said surface;
wherein one or more of said thermal elements are controlled to merge adsorbed fluids on said surface.

55. The microfluidic manipulator of claim 54 wherein said individually controllable thermal elements are controlled to produce a surface temperature on a portion of said surface sufficient to adsorb fluids onto said portion of said surface.

56. The microfluidic manipulator of claim 54 wherein said individually controllable thermal elements are controlled to produce a surface temperature on a portion of said surface sufficient to desorb adsorbed fluids from said portion of said surface.

57. The microfluidic manipulator of claim 54 further comprising a power source for providing electrical signals to said thermal elements.

58. The microfluidic manipulator of claim 57 wherein said power source is selected from the group consisting of a power supply, batteries, analog or digital output modules, a pulse generator and a programmable DC power supply.

59. The microfluidic manipulator of claim 57 wherein the amplitude of said electrical signal is controlled by said power source.

60. The microfluidic manipulator of claim 57 wherein the phase and delay of said electrical signal is controlled by said power source.

61. The microfluidic manipulator of claim 57 wherein the frequency of said electrical signal is controlled by said power source.

62. The microfluidic manipulator of claim 57 wherein the pulse width of said electrical signal is controlled by said power source.

63. The microfluidic manipulator of claim 57 wherein the current limit of said electrical signal is controlled by said power source.

64. The microfluidic manipulator of claim 57 wherein said electrical signal is programmably controlled.

65. The microfluidic manipulator of claim 57 wherein said electrical signal is manually controlled.

66. The microfluidic manipulator of claim 54 further comprising a means for the selection of which of said thermal elements receive said electrical signals.

67. The microfluidic manipulator of claim 66 wherein said thermal elements selection means is selected from the group consisting of relays, switches, multiplexers, data acquisition modules, field programmable gate arrays, and application specific integrated circuits.

68. The microfluidic manipulator of claim 66 wherein said thermal elements selection means provides for two or more of said thermal elements to be collectively selected.

69. The microfluidic manipulator of claim 54 wherein said thermal elements are connected in series with resistors for monitoring the current through said thermal elements.

70. The microfluidic manipulator of claim 69 wherein said thermal elements are feedback controlled by said monitoring current through said thermal elements.

71. The microfluidic manipulator of claim 54 wherein said thermal elements protrude from said surface.

72. The microfluidic manipulator of claim 54 wherein said thermal elements are flush with said surface.

73. The microfluidic manipulator of claim 54 wherein said thermal elements are within said material beneath said surface.

74. The microfluidic manipulator of claim 54 wherein said thermal elements take the form of round dots on said surface.

75. The microfluidic manipulator of claim 54 wherein said thermal elements take the form of square dots on said surface.

76. The microfluidic manipulator of claim 54 wherein said thermal elements take the form of round and square dots on said surface.

77. The microfluidic manipulator of claim 54 wherein said thermal elements take the form of straight lines.

78. The microfluidic manipulator of claim 54 wherein said thermal elements take the form of curved lines.

79. The microfluidic manipulator of claim 54 wherein said thermal elements take the form of straight lines and curved lines.

80. The microfluidic manipulator of claim 54 wherein said thermal elements take the form of both dots and lines.

81. The microfluidic manipulator of claim 54 wherein said thermal elements are arranged uniformly spaced with respect to each other.

82. The microfluidic manipulator of claim 54 wherein said thermal elements are arranged unevenly spaced with respect to each other.

83. The microfluidic manipulator of claim 54 wherein said thermal elements take the form of straight or curved lines that cross each other on said surface.

84. The microfluidic manipulator of claim 54 wherein said thermal elements take the form of straight or curved lines that do not cross each other on said surface.

85. The microfluidic manipulator of claim 54 wherein said thermal elements are arranged as an orthogonal structure on said surface.

86. The microfluidic manipulator of claim 54 wherein said thermal elements are arranged as non-intersecting closed lines on said surface.

87. The microfluidic manipulator of claim 54 wherein said thermal elements are arranged as concentric circles on said surface.

88. The microfluidic manipulator of claim 54 wherein said thermal elements are resistive heaters.

89. The microfluidic manipulator of claim 54 wherein said thermal elements are Peltier Effect junctions.

90. The microfluidic manipulator of claim 54 wherein said thermal elements are a combination of resistive heaters and Peltier Effect junctions.

91. The microfluidic manipulator of claim 54 wherein at least one of said thermal elements is a thin metal film selected from the group consisting of gold, platinum, palladium, aluminum, nickel, copper and chrome.

92. The microfluidic manipulator of claim 54 wherein at least one of said thermal elements is made of a compound selected from the group consisting of hafnium diboride, titanium-tungsten nitride, cobalt silicide, titanium silicide, molybdenum silicide, tungsten silicide and magnesium silicide.

93. The microfluidic manipulator of claim 54 wherein said thermal elements are made by ion implantation.

94. The microfluidic manipulator of claim 54 wherein said material is a semiconductor selected from the group consisting of silicon, gallium arsenide and germanium.

95. The microfluidic manipulator of claim 54 wherein said material is an insulator selected from the group consisting of silicon dioxide, silicon nitride, silicon carbide, diamond, sapphire, ceramic, silica glass, fused silica, fused quartz and mica.

96. The microfluidic manipulator of claim 54 wherein said material is a polymer selected from the group consisting of silicone rubber and polyimide.

97. The microfluidic manipulator of claim 54 wherein said material is rigid.

98. The microfluidic manipulator of claim 54 wherein said material is flexible.

99. The microfluidic manipulator of claim 54 wherein said adsorbed fluid is desorbed to a nearby detector device.

100. The microfluidic manipulator of claim 99 wherein said detector device is a MEMS sensor.

101. The microfluidic manipulator of claim 100 wherein said MEMS sensor is a microcantilever detector.

102. The microfluidic manipulator of claim 99 wherein said detector device is a surface acoustic wave detector.

103. The microfluidic manipulator of claim 99 wherein said detector device is an anion mobility mass spectrometer.

104. The microfluidic manipulator of claim 54 wherein said material is integrated with a detector device.

105. The microfluidic manipulator of claim 104 wherein said detector device is a MEMS sensor.

106. The microfluidic manipulator of claim 105 wherein said MEMS sensor is a microcantilever detector.

107. A microfluidic manipulator for an adsorbed fluid, comprising:
a material having a surface for adsorbing fluids, said material provided with a plurality of individually controllable thermal elements that produce thermal gradients on said surface that produce surface tension gradients at the interface between the adsorbed fluid and said surface sufficient to cause the adsorbed fluid to move on said surface;
wherein one or more of said thermal elements are controlled to subdivide adsorbed fluids on said surface.

108. The microfluidic manipulator of claim 107 wherein said individually controllable thermal elements are controlled to produce a surface temperature on a portion of said surface sufficient to adsorb fluids onto said portion of said surface.

109. The microfluidic manipulator of claim 107 wherein said individually controllable thermal elements are controlled to produce a surface temperature on a portion of said surface sufficient to desorb adsorbed fluids from said portion of said surface.

110. The microfluidic manipulator of claim 107 further comprising a power source for providing electrical signals to said thermal elements.

111. The microfluidic manipulator of claim 110 wherein said power source is selected from the group consisting of a power supply, batteries, analog or digital output modules, a pulse generator and a programmable DC power supply.

112. The microfluidic manipulator of claim 110 wherein the amplitude of said electrical signal is controlled by said power source.

113. The microfluidic manipulator of claim 110 wherein the phase and delay of said electrical signal is controlled by said power source.

114. The microfluidic manipulator of claim 110 wherein the frequency of said electrical signal is controlled by said power source.

115. The microfluidic manipulator of claim 110 wherein the pulse width of said electrical signal is controlled by said power source.

116. The microfluidic manipulator of claim 110 wherein the current limit of said electrical signal is controlled by said power source.

117. The microfluidic manipulator of claim 110 wherein said electrical signal is programmably controlled.

118. The microfluidic manipulator of claim 110 wherein said electrical signal is manually controlled.

119. The microfluidic manipulator of claim 107 further comprising a means for the selection of which of said thermal elements receive said electrical signals.

120. The microfluidic manipulator of claim 119 wherein said thermal elements selection means is selected from the group consisting of relays, switches, multiplexers, data acquisition modules, field programmable gate arrays, and application specific integrated circuits.

121. The microfluidic manipulator of claim 119 wherein said thermal elements selection means provides for two or more of said thermal elements to be collectively selected.

122. The microfluidic manipulator of claim 107 wherein said thermal elements are connected in series with resistors for monitoring the current through said thermal elements.

123. The microfluidic manipulator of claim 122 wherein said thermal elements are feedback controlled by said monitoring current through said thermal elements.

124. The microfluidic manipulator of claim 107 wherein said thermal elements protrude from said surface.

125. The microfluidic manipulator of claim 107 wherein said thermal elements are flush with said surface.

126. The microfluidic manipulator of claim 107 wherein said thermal elements are within said material beneath said surface.

127. The microfluidic manipulator of claim 107 wherein said thermal elements take the form of round dots on said surface.

128. The microfluidic manipulator of claim 107 wherein said thermal elements take the form of square dots on said surface.

129. The microfluidic manipulator of claim 107 wherein said thermal elements take the form of round and square dots on said surface.

130. The microfluidic manipulator of claim 107 wherein said thermal elements take the form of straight lines.

131. The microfluidic manipulator of claim 107 wherein said thermal elements take the form of curved lines.

132. The microfluidic manipulator of claim 107 wherein said thermal elements take the form of straight lines and curved lines.

133. The microfluidic manipulator of claim 107 wherein said thermal elements take the form of both dots and lines.

134. The microfluidic manipulator of claim 107 wherein said thermal elements are arranged uniformly spaced with respect to each other.

135. The microfluidic manipulator of claim 107 wherein said thermal elements are arranged unevenly spaced with respect to each other.

136. The microfluidic manipulator of claim 107 wherein said thermal elements take the form of straight or curved lines that cross each other on said surface.

137. The microfluidic manipulator of claim 107 wherein said thermal elements take the form of straight or curved lines that do not cross each other on said surface.

138. The microfluidic manipulator of claim 107 wherein said thermal elements are arranged as an orthogonal structure on said surface.

139. The microfluidic manipulator of claim 107 wherein said thermal elements are arranged as non-intersecting closed lines on said surface.

140. The microfluidic manipulator of claim 107 wherein said thermal elements are arranged as concentric circles on said surface.

141. The microfluidic manipulator of claim 107 wherein said thermal elements are resistive heaters.

142. The microfluidic manipulator of claim 107 wherein said thermal elements are Peltier Effect junctions.

143. The microfluidic manipulator of claim 107 wherein said thermal elements are a combination of resistive heaters and Peltier Effect junctions.

144. The microfluidic manipulator of claim 107 wherein at least one of said thermal elements is a thin metal film selected from the group consisting of gold, platinum, palladium, aluminum, nickel, copper and chrome.

145. The microfluidic manipulator of claim 107 wherein at least one of said thermal elements is made of a compound selected from the group consisting of hafnium diboride, titanium-tungsten nitride, cobalt silicide, titanium silicide, molybdenum silicide, tungsten silicide and magnesium silicide.

146. The microfluidic manipulator of claim 107 wherein said thermal elements are made by ion implantation.

147. The microfluidic manipulator of claim 107 wherein said material is a semiconductor selected from the group consisting of silicon, gallium arsenide and germanium.

148. The microfluidic manipulator of claim 107 wherein said material is an insulator selected from the group consisting of silicon dioxide, silicon nitride, silicon carbide, diamond, sapphire, ceramic, silica glass, fused silica, fused quartz and mica.

149. The microfluidic manipulator of claim 107 wherein said material is a polymer selected from the group consisting of silicone rubber and polyimide.

150. The microfluidic manipulator of claim 107 wherein said material is rigid.

151. The microfluidic manipulator of claim 107 wherein said material is flexible.

152. The microfluidic manipulator of claim 107 wherein said adsorbed fluid is desorbed to a nearby detector device.

153. The microfluidic manipulator of claim 152 wherein said detector device is a MEMS sensor.

154. The microfluidic manipulator of claim 153 wherein said MEMS sensor is a microcantilever detector.

155. The microfluidic manipulator of claim 152 wherein said detector device is a surface acoustic wave detector.

156. The microfluidic manipulator of claim 152 wherein said detector device is an anion mobility mass spectrometer.

157. The microfluidic manipulator of claim 107 wherein said material is integrated with a detector device.

158. The microfluidic manipulator of claim 157 wherein said detector device is a MEMS sensor.

159. The microfluidic manipulator of claim 158 wherein said MEMS sensor is a microcantilever detector.

160. A microfluidic manipulator for an adsorbed fluid, comprising:
a material having a surface for adsorbing fluids, said material provided with a plurality of individually controllable thermal elements that produce thermal gradients on said surface that produce surface tension gradients at the interface between the adsorbed fluid and said surface sufficient to cause the adsorbed fluid to move on said surface;
wherein one or more of said thermal elements are controlled to separate adsorbed fluids on said surface.

161. The microfluidic manipulator of claim 160 wherein said individually controllable thermal elements are controlled to produce a surface temperature on a portion of said surface sufficient to adsorb fluids onto said portion of said surface.

162. The microfluidic manipulator of claim 160 wherein said individually controllable thermal elements are controlled to produce a surface temperature on a portion of said surface sufficient to desorb adsorbed fluids from said portion of said surface.

163. The microfluidic manipulator of claim 160 further comprising a power source for providing electrical signals to said thermal elements.

164. The microfluidic manipulator of claim 163 wherein said power source is selected from the group consisting of a power supply, batteries, analog or digital output modules, a pulse generator and a programmable DC power supply.

165. The microfluidic manipulator of claim 163 wherein the amplitude of said electrical signal is controlled by said power source.

166. The microfluidic manipulator of claim 163 wherein the phase and delay of said electrical signal is controlled by said power source.

167. The microfluidic manipulator of claim 163 wherein the frequency of said electrical signal is controlled by said power source.

168. The microfluidic manipulator of claim 163 wherein the pulse width of said electrical signal is controlled by said power source.

169. The microfluidic manipulator of claim 163 wherein the current limit of said electrical signal is controlled by said power source.

170. The microfluidic manipulator of claim 163 wherein said electrical signal is programmably controlled.

171. The microfluidic manipulator of claim 163 wherein said electrical signal is manually controlled.

172. The microfluidic manipulator of claim 160 further comprising a means for the selection of which of said thermal elements receive said electrical signals.

173. The microfluidic manipulator of claim 172 wherein said thermal elements selection means is selected from the group consisting of relays, switches, multiplexers, data acquisition modules, field programmable gate arrays, and application specific integrated circuits.

174. The microfluidic manipulator of claim 172 wherein said thermal elements selection means provides for two or more of said thermal elements to be collectively selected.

175. The microfluidic manipulator of claim 160 wherein said thermal elements are connected in series with resistors for monitoring the current through said thermal elements.

176. The microfluidic manipulator of claim 175 wherein said thermal elements are feedback controlled by said monitoring current through said thermal elements.

177. The microfluidic manipulator of claim 160 wherein said thermal elements protrude from said surface.

178. The microfluidic manipulator of claim 160 wherein said thermal elements are flush with said surface.

179. The microfluidic manipulator of claim 160 wherein said thermal elements are within said material beneath said surface.

180. The microfluidic manipulator of claim 160 wherein said thermal elements take the form of round dots on said surface.

181. The microfluidic manipulator of claim 160 wherein said thermal elements take the form of square dots on said surface.

182. The microfluidic manipulator of claim 160 wherein said thermal elements take the form of round and square dots on said surface.

183. The microfluidic manipulator of claim 160 wherein said thermal elements take the form of straight lines.

184. The microfluidic manipulator of claim 160 wherein said thermal elements take the form of curved lines.

185. The microfluidic manipulator of claim 160 wherein said thermal elements take the form of straight lines and curved lines.

186. The microfluidic manipulator of claim 160 wherein said thermal elements take the form of both dots and lines.

187. The microfluidic manipulator of claim 160 wherein said thermal elements are arranged uniformly spaced with respect to each other.

188. The microfluidic manipulator of claim 160 wherein said thermal elements are arranged unevenly spaced with respect to each other.

189. The microfluidic manipulator of claim 160 wherein said thermal elements take the form of straight or curved lines that cross each other on said surface.

190. The microfluidic manipulator of claim 160 wherein said thermal elements take the form of straight or curved lines that do not cross each other on said surface.

191. The microfluidic manipulator of claim 160 wherein said thermal elements are arranged as an orthogonal structure on said surface.

192. The microfluidic manipulator of claim 160 wherein said thermal elements are arranged as non-intersecting closed lines on said surface.

193. The microfluidic manipulator of claim 160 wherein said thermal elements are arranged as concentric circles on said surface.

194. The microfluidic manipulator of claim 160 wherein said thermal elements are resistive heaters.

195. The microfluidic manipulator of claim 160 wherein said thermal elements are Peltier Effect junctions.

196. The microfluidic manipulator of claim 160 wherein said thermal elements are a combination of resistive heaters and Peltier Effect junctions.

197. The microfluidic manipulator of claim 160 wherein at least one of said thermal elements is a thin metal film selected from the group consisting of gold, platinum, palladium, aluminum, nickel, copper and chrome.

198. The microfluidic manipulator of claim 160 wherein at least one of said thermal elements is made of a compound selected from the group consisting of hafnium diboride, titanium-tungsten nitride, cobalt silicide, titanium silicide, molybdenum silicide, tungsten silicide and magnesium silicide.

199. The microfluidic manipulator of claim 160 wherein said thermal elements are made by ion implantation.

200. The microfluidic manipulator of claim 160 wherein said material is a semiconductor selected from the group consisting of silicon, gallium arsenide and germanium.

201. The microfluidic manipulator of claim 160 wherein said material is an insulator selected from the group consisting of silicon dioxide, silicon nitride, silicon carbide, diamond, sapphire, ceramic, silica glass, fused silica, fused quartz and mica.

202. The microfluidic manipulator of claim 160 wherein said material is a polymer selected from the group consisting of silicone rubber and polyimide.

203. The microfluidic manipulator of claim 160 wherein said material is rigid.

204. The microfluidic manipulator of claim 160 wherein said material is flexible.

205. The microfluidic manipulator of claim 160 wherein said adsorbed fluid is desorbed to a nearby detector device.

206. The microfluidic manipulator of claim 205 wherein said detector device is a MEMS sensor.

207. The microfluidic manipulator of claim 206 wherein said MEMS sensor is a microcantilever detector.

208. The microfluidic manipulator of claim 205 wherein said detector device is a surface acoustic wave detector.

209. The microfluidic manipulator of claim 205 wherein said detector device is an anion mobility mass spectrometer.

210. The microfluidic manipulator of claim 160 wherein said material is integrated with a detector device.

211. The microfluidic manipulator of claim 210 wherein said detector device is a MEMS sensor.

212. The microfluidic manipulator of claim 211 wherein said MEMS sensor is a microcantilever detector.

213. A microfluidic manipulator for an adsorbed fluid, comprising:
a material having a surface for adsorbing fluids, said material provided with a plurality of individually controllable thermal elements that produce thermal gradients on said surface that produce surface tension gradients at the interface between the adsorbed fluid and said surface sufficient to cause the adsorbed fluid to move on said surface;
wherein one or more of said thermal elements are controlled to sort adsorbed fluids on said surface.

214. The microfluidic manipulator of claim 213 wherein said individually controllable thermal elements are controlled to produce a surface temperature on a portion of said surface sufficient to adsorb fluids onto said portion of said surface.

215. The microfluidic manipulator of claim 213 wherein said individually controllable thermal elements are controlled to produce a surface temperature on a portion of said surface sufficient to desorb adsorbed fluids from said portion of said surface.

216. The microfluidic manipulator of claim 213 further comprising a power source for providing electrical signals to said thermal elements.

217. The microfluidic manipulator of claim 216 wherein said power source is selected from the group consisting of a power supply, batteries, analog or digital output modules, a pulse generator and a programmable DC power supply.

218. The microfluidic manipulator of claim 216 wherein the amplitude of said electrical signal is controlled by said power source.

219. The microfluidic manipulator of claim 216 wherein the phase and delay of said electrical signal is controlled by said power source.

220. The microfluidic manipulator of claim 216 wherein the frequency of said electrical signal is controlled by said power source.

221. The microfluidic manipulator of claim 216 wherein the pulse width of said electrical signal is controlled by said power source.

222. The microfluidic manipulator of claim 216 wherein the current limit of said electrical signal is controlled by said power source.

223. The microfluidic manipulator of claim 216 wherein said electrical signal is programmably controlled.

224. The microfluidic manipulator of claim 216 wherein said electrical signal is manually controlled.

225. The microfluidic manipulator of claim 213 further comprising a means for the selection of which of said thermal elements receive said electrical signals.

226. The microfluidic manipulator of claim 225 wherein said thermal elements selection means is selected from the group consisting of relays, switches, multiplexers, data acquisition modules, field programmable gate arrays, and application specific integrated circuits.

227. The microfluidic manipulator of claim 225 wherein said thermal elements selection means provides for two or more of said thermal elements to be collectively selected.

228. The microfluidic manipulator of claim 213 wherein said thermal elements are connected in series with resistors for monitoring the current through said thermal elements.

229. The microfluidic manipulator of claim 228 wherein said thermal elements are feedback controlled by said monitoring current through said thermal elements.

230. The microfluidic manipulator of claim 213 wherein said thermal elements protrude from said surface.

231. The microfluidic manipulator of claim 213 wherein said thermal elements are flush with said surface.

232. The microfluidic manipulator of claim 213 wherein said thermal elements are within said material beneath said surface.

233. The microfluidic manipulator of claim 213 wherein said thermal elements take the form of round dots on said surface.

234. The microfluidic manipulator of claim 213 wherein said thermal elements take the form of square dots on said surface.

235. The microfluidic manipulator of claim 213 wherein said thermal elements take the form of round and square dots on said surface.

236. The microfluidic manipulator of claim 213 wherein said thermal elements take the form of straight lines.

237. The microfluidic manipulator of claim 213 wherein said thermal elements take the form of curved lines.

238. The microfluidic manipulator of claim 213 wherein said thermal elements take the form of straight lines and curved lines.

239. The microfluidic manipulator of claim 213 wherein said thermal elements take the form of both dots and lines.

240. The microfluidic manipulator of claim 213 wherein said thermal elements are arranged uniformly spaced with respect to each other.

241. The microfluidic manipulator of claim 213 wherein said thermal elements are arranged unevenly spaced with respect to each other.

242. The microfluidic manipulator of claim 213 wherein said thermal elements take the form of straight or curved lines that cross each other on said surface.

243. The microfluidic manipulator of claim 213 wherein said thermal elements take the form of straight or curved lines that do not cross each other on said surface.

244. The microfluidic manipulator of claim 213 wherein said thermal elements are arranged as an orthogonal structure on said surface.

245. The microfluidic manipulator of claim 213 wherein said thermal elements are arranged as non-intersecting closed lines on said surface.

246. The microfluidic manipulator of claim 213 wherein said thermal elements are arranged as concentric circles on said surface.

247. The microfluidic manipulator of claim 213 wherein said thermal elements are resistive heaters.

248. The microfluidic manipulator of claim 213 wherein said thermal elements are Peltier Effect junctions.

249. The microfluidic manipulator of claim 213 wherein said thermal elements are a combination of resistive heaters and Peltier Effect junctions.

250. The microfluidic manipulator of claim 213 wherein at least one of said thermal elements is a thin metal film selected from the group consisting of gold, platinum, palladium, aluminum, nickel, copper and chrome.

251. The microfluidic manipulator of claim 213 wherein at least one of said thermal elements is made of a compound selected from the group consisting of hafnium diboride, titanium-tungsten nitride, cobalt silicide, titanium silicide, molybdenum silicide, tungsten silicide and magnesium silicide.

252. The microfluidic manipulator of claim 213 wherein said thermal elements are made by ion implantation.

253. The microfluidic manipulator of claim 213 wherein said material is a semiconductor selected from the group consisting of silicon, gallium arsenide and germanium.

254. The microfluidic manipulator of claim 213 wherein said material is an insulator selected from the group consisting of silicon dioxide, silicon nitride, silicon carbide, diamond, sapphire, ceramic, silica glass, fused silica, fused quartz and mica.

255. The microfluidic manipulator of claim 213 wherein said material is a polymer selected from the group consisting of silicone rubber and polyimide.

256. The microfluidic manipulator of claim 213 wherein said material is rigid.

257. The microfluidic manipulator of claim 213 wherein said material is flexible.

258. The microfluidic manipulator of claim 213 wherein said adsorbed fluid is desorbed to a nearby detector device.

259. The microfluidic manipulator of claim 258 wherein said detector device is a MEMS sensor.

260. The microfluidic manipulator of claim 259 wherein said MEMS sensor is a microcantilever detector.

261. The microfluidic manipulator of claim 258 wherein said detector device is a surface acoustic wave detector.

262. The microfluidic manipulator of claim 258 wherein said detector device is an anion mobility mass spectrometer.

263. The microfluidic manipulator of claim 213 wherein said material is integrated with a detector device.

264. The microfluidic manipulator of claim 263 wherein said detector device is a MEMS sensor.

265. The microfluidic manipulator of claim 264 wherein said MEMS sensor is a microcantilever detector.
